(19) United States
(12) Patent Application Publication
(10) Pub. No.: US 2026/0095263 A1
(43) Pub. Date: Apr. 2, 2026

(54) WIRELESS TERMINAL TEST DEVICE AND CARRIER FREQUENCY VARIATION DISPLAY METHOD FOR THE SAME

(71) Applicant: ANRITSU CORPORATION, Kanagawa (JP)

(72) Inventors: Shigeharu ARAI, Kanagawa (JP); Takayuki KOGUCHI, Kanagawa (JP); Katsuo SAKURAI, Kanagawa (JP); Kengo KIKUCHI, Kanagawa (JP)

(21) Appl. No.: 19/272,007

(22) Filed: Jul. 17, 2025

(30) Foreign Application Priority Data
Sep. 30, 2024 (JP) 2024-170452

(51) Int. Cl. H04B 17/00; H04B 17/20; H04B 17/364

(52) U.S. Cl. CPC H04B 17/0087; H04B 17/201; H04B 17/364

(57) ABSTRACT

A satellite orbit calculation unit that calculates a satellite orbit based on position information and a movement speed of a satellite at a start of measurement, a Doppler shift calculation unit that calculates a Doppler shift amount and displays, on the display unit, a difference between a carrier frequency of a downlink signal and a carrier frequency at the start of the measurement and a difference between a carrier frequency of an uplink signal and the carrier frequency at the start of the measurement, a Doppler shift removal unit that removes a Doppler shift added to the uplink signal based on the calculated Doppler shift amount, and a frequency error measurement unit that calculates a difference between the carrier frequency after the Doppler shift is removed and the carrier frequency at the start of the measurement and displays the difference on the display unit are provided.

### Technical Field

The present invention relates to a wireless terminal test device that simulates a base station of a wireless communication system to test a wireless terminal.

### Background Art

In a case where a wireless terminal, such as an Internet of Things (IoT) terminal, that uses wireless communication for network connection is developed, it is necessary to test whether or not the developed wireless terminal can normally perform communication. Therefore, a test in which a wireless terminal to be tested is connected to a test device that operates as a simulated base station that simulates a function of an actual base station, communication is performed between the test device and the wireless terminal, and content of the communication is checked is performed.

A narrowband Internet of Things (NB-IoT) is standardized as communication means of the IoT terminal. In addition, a non-terrestrial network (NTN) that is a non-ground network using a satellite, which can be used in the NB-IoT, is also defined.

Patent Document 1 describes that in the NTN, uplink synchronization is executed by appropriately setting a timing advance (TA) between an airborne base station and a terminal.

### Related art Document

### Patent Document

Patent Document 1 WO2023/013008

### Disclosure of the Invention

### Problem that the Invention is to Solve

In a case where communication of a wireless terminal of an NB-IoT via an NTN is simulated, a satellite is inserted between a base station and the wireless terminal, and the satellite is moving, so that a variation in a carrier frequency occurs because of a Doppler effect (Doppler shift).

As a period of call connection increases, a variation range of the carrier frequency increases, and a variation in the carrier frequency that greatly exceeds a subcarrier spacing of 15 kHz or 3.75 kHz occurs.

Even in a case where frequency correction is attempted during a reception process, only correction within half of the subcarrier spacing can be corrected. Therefore, it is necessary to correct the carrier frequency before the reception process. However, since the correction can be performed correctly only in a case where orbit calculation of the satellite is matched between a wireless terminal side and a base station side, if it is not matched, a call is disconnected, and it takes time to specify an abnormal point.

Therefore, an object of the present invention is to provide a wireless terminal test device that can easily specify that a call is disconnected because of a variation in a carrier frequency.

### Means for solving the problem

A wireless terminal test device according to the present invention is a wireless terminal test device (1) that simulates communication with a wireless terminal (100) via a satellite to perform a test for the wireless terminal, the wireless terminal test device includes: a display unit (19) that displays time-dependent changes in a theoretical value and a measured value of a carrier frequency of an uplink signal.

With this configuration, the time-dependent changes in the theoretical value and the measured value of the carrier frequency of the uplink signal are displayed. Therefore, it is possible to easily check a difference between the theoretical value and the measured value of the carrier frequency, and to easily specify that a call is disconnected because of the variation in the carrier frequency.

In addition, in the wireless terminal test device according to the present invention, in addition to the time-dependent changes in the theoretical value and the measured value of the carrier frequency of the uplink signal, a time-dependent change in a theoretical value of a carrier frequency of a downlink signal is displayed on the display unit.

With this configuration, in addition to in addition to the time-dependent changes in the theoretical value and the measured value of the carrier frequency of the uplink signal, the time-dependent change in the theoretical value of the carrier frequency of the downlink signal is displayed. Therefore, it is possible to also check the time-dependent change in the theoretical value of the carrier frequency of the downlink signal, and to easily specify that the call is disconnected because of the variation in the carrier frequency.

In addition, in the wireless terminal test device according to the present invention, the time-dependent change in the carrier frequency is displayed by a difference from a carrier frequency at a start of measurement.

With this configuration, the time-dependent change in the carrier frequency is displayed by the difference from the carrier frequency at the start of the measurement. Therefore, it is possible to easily check the change in the carrier frequency, and to easily specify that the call is disconnected because of the variation in the carrier frequency.

A carrier frequency variation display method according to the present invention is a carrier frequency variation display method for a wireless terminal test device (1) that simulates communication with a wireless terminal (100) via a satellite to perform a test for the wireless terminal, the carrier frequency variation display method includes: a step of calculating a satellite orbit based on position information and a movement speed of the satellite at a start of measurement; a step of calculating a Doppler shift amount between the satellite and the wireless terminal based on the satellite orbit and position information of the wireless terminal; a step of displaying, as theoretical values, a difference between a carrier frequency of a downlink signal and a carrier frequency at the start of the measurement and a difference between a carrier frequency of an uplink signal and the carrier frequency at the start of the measurement, based on the calculated Doppler shift amount; and a step of displaying, as a measured value, a difference between a carrier frequency of an uplink signal after a Doppler shift is removed and the carrier frequency at the start of the measurement, based on the calculated Doppler shift amount.

With this configuration, the time-dependent changes in the theoretical value and the measured value of the carrier frequency of the uplink signal, and the time-dependent change in the theoretical value of the carrier frequency of the downlink signal are displayed as differences from the carrier frequency at the start of the measurement. Therefore, it is possible to easily check the change in the carrier frequency, and to easily specify that a call is disconnected because of a variation in the carrier frequency.

### Advantage of the Invention

The present invention can provide a wireless terminal test device that can easily specify that a call is disconnected because of a variation in a carrier frequency.

### Brief Description of the Drawings

FIG. 1 is a block diagram showing a wireless terminal test device according to an embodiment of the present invention.

FIG. 2 is a diagram showing a display example of time-dependent changes in carrier frequencies of a downlink signal and an uplink signal of the wireless terminal test device according to the embodiment of the present invention.

FIG. 3 is a flowchart illustrating a procedure of a carrier frequency display process of the wireless terminal test device according to the embodiment of the present invention.

### Best Mode for Carrying Out the Invention

Hereinafter, a wireless terminal test device according to an embodiment of the present invention will be described in detail with reference to the drawings.

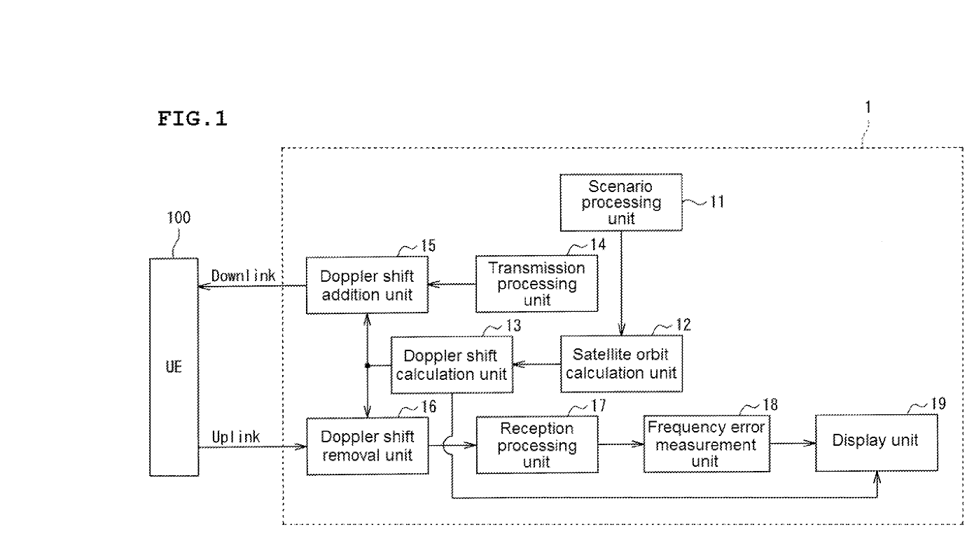

In FIG. 1, a wireless terminal test device 1 according to the embodiment of the present invention is connected to user equipment (UE) 100 as a wireless terminal in a wired manner via a coaxial cable or the like, and performs a measurement test by simulating a base station and transmitting a radio frequency (RF) signal to and receiving an RF signal from the UE 100.

The wireless terminal test device 1 includes a scenario processing unit 11, a satellite orbit calculation unit 12, a Doppler shift calculation unit 13, a transmission processing unit 14, a Doppler shift addition unit 15, a Doppler shift removal unit 16, a reception processing unit 17, a frequency error measurement unit 18, and a display unit 19.

The scenario processing unit 11 creates a scenario for simulating the base station based on a setting for simulating the base station input from a user, and simulates the base station based on the scenario. In a case of performing a test of communication via a NTN, position information of a satellite and the UE 100 and a movement speed of the satellite are set in the scenario.

The satellite orbit calculation unit 12 calculates a satellite orbit based on the position information and the movement speed of the satellite at a start of measurement.

The Doppler shift calculation unit 13 calculates a Doppler shift amount between the satellite and the UE 100 based on the satellite orbit and the position information of the UE 100. The Doppler shift calculation unit 13 displays, on the display unit 19, a difference between a carrier frequency of a downlink signal and a carrier frequency at the start of the measurement and a difference between a carrier frequency of an uplink signal and the carrier frequency at the start of the measurement, as theoretical values, based on the calculated Doppler shift amount.

The transmission processing unit 14 generates the downlink signal including notification information necessary for call connection of the UE 100.

The Doppler shift addition unit 15 calculates a Doppler shift amount caused by satellite movement based on the Doppler shift amount calculated by the Doppler shift calculation unit 13, and adds the Doppler shift to the downlink signal generated by the transmission processing unit 14 and transmits the signal.

The Doppler shift removal unit 16 removes the Doppler shift added to the uplink signal based on the Doppler shift amount calculated by the Doppler shift calculation unit 13, and outputs the signal to the reception processing unit 17.

The reception processing unit 17 performs a reception process such as a timing synchronization process and a demodulation process of the received uplink signal, and outputs a signal subjected to the reception process.

The frequency error measurement unit 18 calculates a difference between the carrier frequency after the Doppler shift is removed by the Doppler shift removal unit 16 and the initial carrier frequency at the start of the measurement, and displays the difference as a measured value on the display unit 19.

The display unit 19 includes an image display device such as a liquid crystal display, and displays an image or the like generated by the Doppler shift calculation unit 13, the frequency error measurement unit 18, or the like.

Here, the wireless terminal test device 1 includes a computer device (not shown) provided with a communication module for communicating with the UE 100. The computer device includes a central processing unit (CPU), a read-only memory (ROM), a random-access memory (RAM), a storage device such as a hard disk device, an input and output port, and a touch panel (none of which is shown).

A program for causing the computer device to function as the wireless terminal test device 1 is stored in the ROM and the hard disk device of the computer device. That is, the computer device functions as the wireless terminal test device 1 by the CPU executing the program stored in the ROM by using the RAM as a work area.

As described above, in the present embodiment, the scenario processing unit 11, the satellite orbit calculation unit 12, the Doppler shift calculation unit 13, and the frequency error measurement unit 18 are configured by the CPU, and the transmission processing unit 14, the Doppler shift addition unit 15, the Doppler shift removal unit 16, and the reception processing unit 17 are configured by the communication module.

In the wireless terminal test device 1 having such a configuration, the Doppler shift calculation unit 13 and the frequency error measurement unit 18 display time-dependent changes in the carrier frequencies of the downlink signal and the uplink signal on the display unit 19.

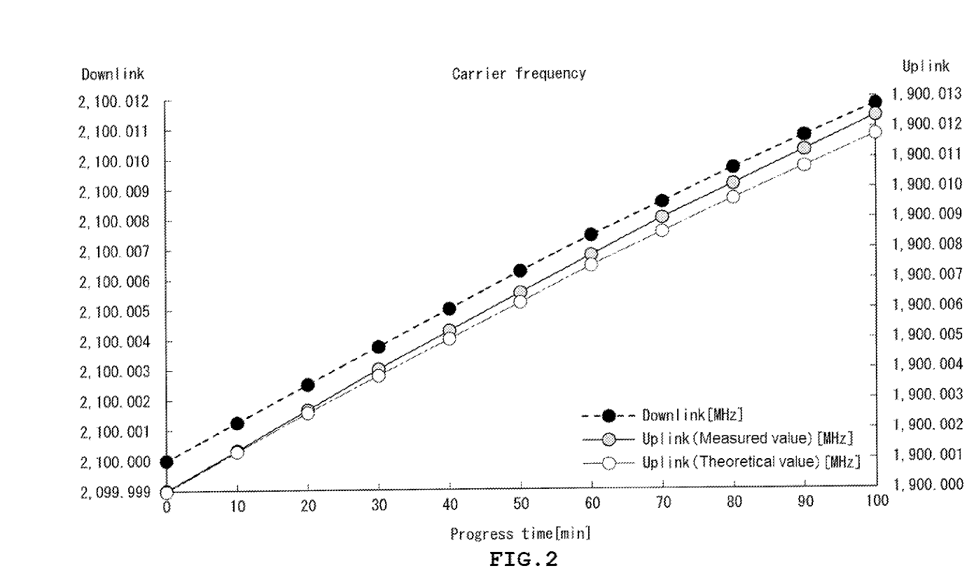

For example, as shown in FIG. 2, the Doppler shift calculation unit 13 and the frequency error measurement unit 18 display, in a graph on the display unit 19, a time-dependent change in the theoretical value of the carrier frequency of the downlink signal and time-dependent changes in the measured value and the theoretical value of the carrier frequency of the uplink signal.

In FIG. 2, it can be seen that the theoretical values of the carrier frequency of the downlink signal and the carrier frequency of the uplink signal increase in the same manner as time elapses, but the measured value of the carrier frequency of the uplink signal increases more steeply than the theoretical values.

As described above, since the changes in the measured value and the theoretical value of the carrier frequency is displayed, it is possible to easily specify that a call is disconnected because of the variation in the carrier frequency.

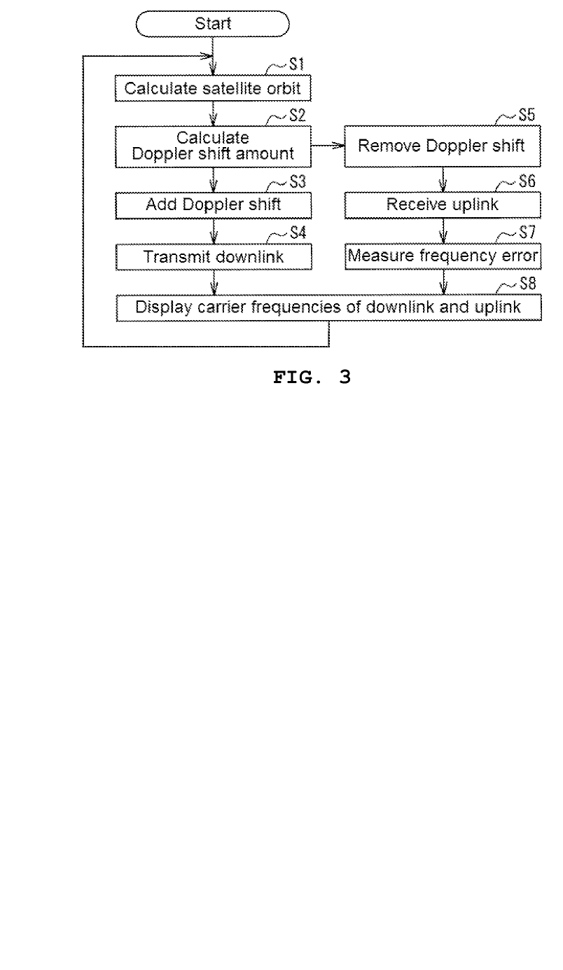

A carrier frequency display process performed by the wireless terminal test device 1 according to the present embodiment configured as described above will be described with reference to FIG. 3. The carrier frequency display process described below is started when a start of the communication with the UE 100 is selected by an operation of the user.

In step S1, the satellite orbit calculation unit 12 calculates the satellite orbit based on the position information and the movement speed of the satellite at the start of the measurement. After the process of step S1 is executed, the Doppler shift calculation unit 13 executes a process of step S2.

In step S2, the Doppler shift calculation unit 13 calculates the Doppler shift amount based on the satellite orbit and the position information of the UE 100. After the process of step S2 is executed, the Doppler shift addition unit 15 executes a process of step S3, and the Doppler shift removal unit 16 executes a process of step S5.

In step S3, the Doppler shift addition unit 15 calculates the Doppler shift amount caused by the satellite movement and adds the Doppler shift amount to the downlink signal generated by the transmission processing unit 14. After the process of step S3 is executed, the Doppler shift addition unit 15 executes a process of step S4.

In step S4, the Doppler shift addition unit 15 transmits the downlink signal to which the Doppler shift is added. After the process of step S4 is executed, the Doppler shift calculation unit 13 executes a process of step S8.

In step S5, the Doppler shift removal unit 16 removes the Doppler shift added to the uplink signal and outputs the signal to the reception processing unit 17. After the process of step S5 is executed, the reception processing unit 17 executes a process of step S6.

In step S6, the reception processing unit 17 receives the uplink signal and performs the reception process. After the process of step S6 is executed, the frequency error measurement unit 18 executes a process of step S7.

In step S7, the frequency error measurement unit 18 calculates the difference between the carrier frequency after the Doppler shift is removed and the initial carrier frequency at the start of the measurement. After the process of step S7 is executed, the frequency error measurement unit 18 executes a process of step S8.

In step S8, the Doppler shift calculation unit 13 displays, on the display unit 19, the time-dependent change in the carrier frequency of the downlink signal and the time-dependent change in the theoretical value of the carrier frequency of the uplink signal, and the frequency error measurement unit 18 displays, on the display unit 19, the time-dependent change in the measured value of the carrier frequency of the uplink signal. After the process of step S8 is executed, the Doppler shift calculation unit 13 and the frequency error measurement unit 18 end the carrier frequency display process.

As described above, in the above-described embodiment, the wireless terminal test device 1 displays the time-dependent changes in the theoretical value and the measured value of the carrier frequency of the uplink signal on the display unit 19.

Accordingly, it is possible to easily check the time-dependent changes in the theoretical value and the measured value of the carrier frequency of the uplink signal, and to easily specify that the call is disconnected because of the variation in the carrier frequency.

In addition, the wireless terminal test device 1 displays, on the display unit 19, the time-dependent change in the theoretical value of the carrier frequency of the downlink signal, in addition to the time-dependent changes in the theoretical value and the measured value of the carrier frequency of the uplink signal.

Accordingly, it is possible to check the time-dependent change in the theoretical value of the carrier frequency of the downlink signal, and to easily specify that the call is disconnected because of the variation in the carrier frequency.

In addition, the wireless terminal test device 1 displays the time-dependent change in the carrier frequency through the difference from the carrier frequency at the start of the measurement.

Accordingly, it is possible to easily check the time-dependent change in the carrier frequency, and to easily specify that the call is disconnected because of the variation in the carrier frequency.

Hitherto, the embodiment of the present invention has been disclosed, but it is clear that changes can be made by those skilled in the art without departing from the scope of the present invention. All such modifications and equivalents are intended to be included in the following claims.

### Description of Reference Numerals and Signs

1: wireless terminal test device

11: scenario processing unit

12: satellite orbit calculation unit

13: Doppler shift calculation unit

14: transmission processing unit

15: Doppler shift addition unit

16: Doppler shift removal unit

17: reception processing unit

18: frequency error measurement unit

19: display unit

100: UE (wireless terminal)

What is claimed is:

1. A wireless terminal test device that simulates communication with a wireless terminal via a satellite to perform a test for the wireless terminal, the wireless terminal test device comprising:
a display unit that displays time-dependent changes in a theoretical value and a measured value of a carrier frequency of an uplink signal.

2. The wireless terminal test device according to claim 1,
wherein, in addition to the time-dependent changes in the theoretical value and the measured value of the carrier frequency of the uplink signal, a time-dependent change in a theoretical value of a carrier frequency of a downlink signal is displayed on the display unit.

3. The wireless terminal test device according to claim 1,
wherein the time-dependent change in the carrier frequency is displayed by a difference from a carrier frequency at a start of measurement.

4. A carrier frequency variation display method for a wireless terminal test device that simulates communication with a wireless terminal via a satellite to perform a test for the wireless terminal, the carrier frequency variation display method comprising:
a step of calculating a satellite orbit based on position information and a movement speed of the satellite at a start of measurement;
a step of calculating a Doppler shift amount between the satellite and the wireless terminal based on the satellite orbit and position information of the wireless terminal;
a step of displaying, as theoretical values, a difference between a carrier frequency of a downlink signal and a carrier frequency at the start of the measurement and a difference between a carrier frequency of an uplink signal and the carrier frequency at the start of the measurement, based on the calculated Doppler shift amount; and
a step of displaying, as a measured value, a difference between a carrier frequency of an uplink signal after a Doppler shift is removed and the carrier frequency at the start of the measurement, based on the calculated Doppler shift amount.
